(19) United States
(12) Patent Application Publication
(10) Pub. No.: US 2008/0186591 A1
(43) Pub. Date: Aug. 7, 2008

(54) Dermatological device having a zoom lens system

(75) Inventors: Gregory B. Altshuler, Lincoln, MA (US); Andrei Erofeev, North Andover, MA (US); Mikhail Smirnov, Burlington, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: PALOMAR MEDICAL TECHNOLOGIES, INC., Burlington, MA (US)

(21) Appl. No.: 11/701,192

(22) Filed: Feb. 1, 2007

(51) Int. Cl. G02B 15/14; G02B 5/00; G02B 5/04

(52) U.S. Cl. 359/703; 359/676; 359/831; 359/894

(57) ABSTRACT

In one aspect, the present invention provides a dermatological device that comprises a optical mask that is adapted to receive a radiation beam, e.g., from an external radiation source via an optical fiber, and to transform the beam into a plurality of beamlets. A zoom lens system is optically coupled to the optical mask so as to receive the beamlets, wherein zoom lens system is capable of focusing the beamlets into a plurality of separate skin portions. The zoom lens system can provide adjustable magnification while substantially preserving the locations of the focused spots within the skin. By way of example, the zoom lens system can be a parfocal inverting optical system.

### BACKGROUND

The present invention relates generally to dermatological optical systems and devices, and more particularly, to such systems and devices with adjustable optics to change various parameters, such as the density of treatment spots within the skin.

Electromagnetic radiation (“EMR” or “radiation”) can be utilized in dermatology in a variety of skin treatment procedures. Such procedures can include, for example, removal of unwanted hair, skin rejuvenation, removal of vascular lesions, acne treatment, treatment of cellulite, pigmented lesions and psoriasis, as well as tattoo removal. Recently, fractional treatment of a target area has been proposed as a way of accelerating the healing process after the application of radiation. However, current dermatological devices designed for applying factional treatment to the skin do not typically allow adjustment of the treatment parameters to address either patient-specific factors, changes in the dermatological conditions that may occur during the course of treatment, or the ability to alter parameters of a system for use in different treatments.

For example, in some cases, it is preferable to treat tissue using fractional technology with a relatively lower density of microbeams per unit of area of tissue. Such cases can be, for example, when treating tissue with EMR at relatively larger power densities. Similarly, in other cases, it may be preferable to use a larger number of microbeams per unit of area of tissue. Such cases can be, for example, when many small microbeams are applied at relatively lower power densities to avoid bulk heating of the tissue.

Presently, such changes in parameters are effected by, for example, using different handpieces designed to different specification. Accordingly, there is a need for enhanced dermatological optical systems and devices, and in particular, for enhanced dermatological systems and devices that can vary fractional treatment to the skin in real-time.

### SUMMARY

In one aspect, the present invention provides a dermatological device that comprises an optical mask that is adapted to receive a radiation beam, e.g., from an external radiation source via an optical fiber, and to transform the beam into a plurality of beamlets. A zoom lens system is optically coupled to the mask so as to receive the beamlets, wherein the zoom lens system is capable of focusing the beamlets into a plurality of separate skin portions. The zoom lens system can provide adjustable magnification, e.g., in a range of about 0.5× to about 5× and more particularly in a range of approximately 1.43× to 2.14×, while substantially preserving the locations of the focused spots within the skin at different values of magnification. In other words, the zoom lens system can provide adjustable magnification while maintaining parfocality. By way of example, the zoom lens system can be a parfocal inverting optical system.

In one embodiment, the mask can be a phase mask that is formed as a plurality of microlenses, where each lens generates one of the beamlets. In some cases, the microlenses exhibit aspherical profiles (e.g., characterized by a conic constant in a range of about 0-10, or, depending on the design, even more preferably in a range of about 0-6), so as to alleviate spherical aberrations effects. Further, the device can include a holder in which the optical mask can be removably and replaceably disposed so as to be in the path of radiation. The holder can, in turn, be mounted, e.g., removably and replaceably, to a body portion of the device, e.g., via one or more magnetic detents.

In a related aspect, the zoom lens system can comprise two pairs of lenses that are movable relative to one another so as to provide a range of magnification values. The lenses can be adapted for movement relative to one another so as to substantially preserve the locations of the focused beamlets in the skin while adjusting their magnification. By way of example, in some embodiments, the lenses of one lens pair are coupled to the two ends of a cylindrical enclosure and the lenses of the other pair are coupled to the two ends of another cylindrical enclosure, where one of the enclosures can be axially positioned within the other. A rotational guide, e.g., in the form of a cam, can be coupled to the enclosures, where the guide can cause axial and non-rotational movements of the lens pairs in opposite directions at a rate adapted to cause magnification of the focused beamlets while substantially preserving their locations in the skin, e.g., preserving the skin depth at which they are focused.

In another aspect, the dermatological device can include a radiation transmissive window, which is adapted for contact with the skin at a surface thereof, through which radiation can be applied to the skin. By way of example, the radiation transmissive window can be a sapphire block. In some embodiments, the radiation transmissive window is coupled to an end block of the device, where the end block includes a plurality of passages through which a cooling fluid can flow so as to extract heat from the window. By way of example, the window can be in thermal contact with a cooling plate, which is, in turn, cooled by the flowing fluid.

In another aspect, the dermatological device can include one or more electrically actuable elements, e.g., in the form of piezoelectric elements, that are coupled to a plurality of lenses of the zoom lens system for causing axial movements thereof. In some embodiments, one or more sensors coupled to the actuable elements can provide information regarding the positions of the lenses, e.g., relative to a reference. A controller, in communication with the sensor(s), can effect application of control signals to the actuable elements to cause movements of the lenses based on the information provided by the sensor(s).

In some embodiments, one ore more electrically actuable elements can cause the movement of a holder in which the optical mask in retained so as to adjust the distance between the mask and the zoom lens so as to alter, e.g., the skin depth at which the beamlets are focused.

In another aspect, a handheld dermatological device is disclosed that includes a optical mask (e.g., in the form of a plurality of microlenses) adapted to receive a radiation beam, and a zoom lens system that is optically coupled to the mask so as to generate an image thereof in the skin. The zoom lens system can provide adjustable magnification of the image while substantially preserving the location of the image in the skin at different values of magnification.

In another aspect, the invention provides a handheld dermatological device, which comprises a port for receiving radiation from a radiation source, and a holder in which at least two optical masks can be disposed, where the holder is adapted for interchangeably positioning one of the masks in the radiation path. The device further includes a zoom lens system that is optically coupled to the optical mask so as to generate an image thereof in the skin. The zoom lens system can provide adjustable magnification, while substantially preserving the location of the image in the skin (e.g., the skin depth at which the image is formed).

In other aspect, a handheld dermatological device is disclosed that includes a handheld housing in which a radiation source, an optical mask and a zoom lens system are disposed. The mask receives radiation from the source, and the zoom lens system is adapted to form an image of the mask in the skin with adjustable magnification. In many embodiments, the zoom lens system provides adjustable magnification while substantially maintaining the location of the mask image in the skin.

In another aspect, the invention provides a handheld dermatological device that includes a handheld housing and a radiation transmissive window coupled to that housing. The window is adapted for receiving radiation through a surface thereof and for applying the radiation to the skin via an opposed surface. A prism is optically coupled to the window (e.g., to a side surface thereof) to facilitate viewing of the surface of a skin portion to which radiation is applied. In some embodiments, a light source (e.g., an LED) is coupled to the housing to illuminate the skin so as to further facilitate viewing thereof.

In yet another aspect, a handheld dermatological device is disclosed that comprises a handheld housing and a radiation transmissive window that is coupled to the housing, where the window has a surface adapted for contact with the skin. A flexible indicator is coupled to that surface (e.g., along its perimeter), where the flexible indicator can be pressed against the skin so as to cause a transient impression therein. In some cases, the flexible indicator is formed of a soft polymeric material.

Further understanding of the invention can be obtained by reference to the following detailed description in conjunction with the associated drawings, which are described briefly below.

### BRIEF DESCRIPTION OF THE DRAWINGS

FIG. 1 schematically depicts a dermatological optical system according to one embodiment;

FIG. 2A is a schematic side view of a handheld dermatological device in accordance with one embodiment;

FIG. 2B schematically depicts a number of the optical elements employed in the handheld device of FIG. 2A;

FIG. 2C schematically depicts an optical fiber having a tapered end suitable for use in dermatological systems in accordance with some embodiments of the invention;

FIG. 3A schematically depicts an optical mask formed as a two dimensional array of microlenses;

FIG. 3B schematically depicts formation of a plurality of beamlets by the array of microlenses shown in FIG. 3A from a radiation beam incident on the lenses;

FIG. 4A schematically depicts a portion of the handheld device shown in FIG. 2A;

FIG. 4B schematically shows a holder utilized in the handheld device of FIGS. 2A and 4A for removably and replaceably mounting an optical mask to a body portion of the device;

FIG. 4C schematically depicts coupling the holder shown in FIG. 4B into a recess provided by a mechanical mount of the handheld device by employing magnetic detents;

FIG. 5 shows an exemplary aspherical profile of microlenses utilized as an optical mask in some embodiments of the invention;

FIG. 6A schematically depicts one embodiment of the zoom lens system of the dermatological optical system of FIG. 1;

FIG. 6B schematically depicts various components of the zoom lens system shown in FIG. 6A;

FIG. 7A schematically depicts the passage of radiation through optical elements of an embodiment of the zoom lens system of a the dermatological optical system shown in FIG. 1, using a first magnification setting;

FIG. 7B schematically depicts the passage of radiation through the device of FIG. 7A at a different magnification setting of the zoom lens system;

FIG. 8A schematically shows a portion of a handheld device according to one embodiment, including an end block portion to which a radiation transmissive window is coupled for applying EMR to the skin;

FIG. 8B schematically depicts the end block shown in FIG. 8A including input and exit ports for introducing a cooling fluid into fluid passages formed in the end block and removing the fluid after it has extracted heat from the window;

FIG. 9A schematically depicts calculated focused spots of EMR that can be obtained by utilizing embodiments of the dermatological optical system of FIG. 1 at a given pitch;

FIG. 9B schematically depicts the calculated focused spots of radiation obtained at a different pitch than shown in FIG. 9A;

FIG. 10 schematically depicts a dermatological optical system in accordance with another embodiment;

FIG. 11 schematically shows an optical mask for generating microbeams of EMR;

FIG. 12 schematically shows another optical mask for generating microbeams of EMR;

FIG. 13A schematically depicts an optical mask formed of a matrix array of cylindrical lenses;

FIG. 13B schematically depicts another optical mask that is also formed of a matrix array of cylindrical lenses;

FIG. 14 schematically shows an optical mask formed of two layers of cylindrical lenses;

FIG. 15 schematically shows an optical mask employing a rotatable mirror to direct a radiation beam to a zoom lens at a discrete set of orientations;

FIG. 16 schematically shows a holder in which two optical masks can be disposed, where the holder can be rotated to interchangeably position the optical masks in the path of incident radiation;

FIG. 17A schematically depicts a dermatological optical system in accordance with another embodiment of the invention;

FIG. 17B shows a schematic perspective view of an optical mask holder suitable for use in the handheld device of FIG. 17A;

FIG. 18 schematically shows a dermatological optical system according to another embodiment;

FIG. 19 schematically depicts a dermatological optical system in accordance with another embodiment in which a radiation source is incorporated;

FIG. 20 schematically depicts a dermatological optical system having a radiation transmissive window through which radiation is applied to the skin and a prism optically coupled to the window so as to facilitate observation of the skin portion under treatment;

FIG. 21 schematically depicts a dermatological optical system according to an embodiment having a radiation transmissive window and a flexible indicator coupled to window;

FIG. 22A is a schematic perspective view of the flexible indicator shown in FIG. 21;

FIG. 22B is a schematic perspective view of a side of the flexible indicator shown in FIG. 22A; and

FIG. 23 is a front schematic view of a detent ring used in an alternate embodiment of the invention.

### DETAILED DESCRIPTION

The present invention generally provides dermatological devices (e.g., handheld devices in many embodiments) that allow producing a plurality of radiation-treated islets within the skin tissue and adjusting the density of the islets, as well as other parameters such as the distance at which the islets are formed, and the shape of the beam and, thus, the shape of the resulting EMR-treated islets. In some embodiments, an optical mask (e.g., an array of microlenses) generates a plurality of beamlets from a received EMR beam and directs those beamlets to a zoom lens system, which, in turn, focuses the beamlets onto an area of tissue or into a volume of tissue. When applied to the tissue, the beamlets for a plurality of EMR-treated islets separated by undamaged tissue. Although typically undamaged, the surrounding tissue may also be lesser damaged, thermally treated, or otherwise differently treated tissue.

The term “optical mask,” as used herein, refers to one or more refractive and/or reflective optical elements that can transform a radiation beam into a plurality of beamlets (sub-beams) or to cause deflection of a radiation beam into a plurality of discrete directions (e.g., akin to a plurality of radiation beams directed in different directions each of which is activated at a different temporal interval). The zoom lens allows adjusting the density of the islets through a change in the magnification of an image of the optical mask formed by the zoom lens in the skin. Further, the optical mask can be replaced with another so as to change the skin depth at which the radiation is focused. Alternatively, or in addition, in some embodiments, the optical mask can be moved relative to the zoom lens to adjust the depth of focus of EMR within the skin.

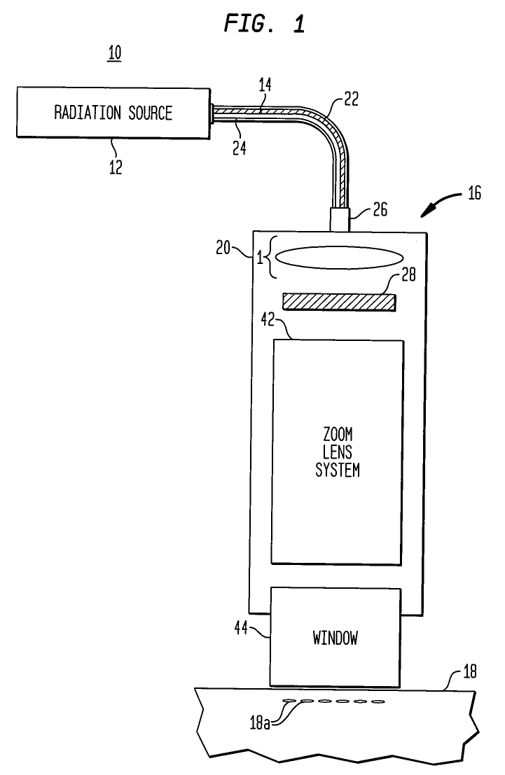

By way of example, FIG. 1 schematically depicts a dermatological optical system 10 in accordance with one embodiment of the invention that includes a radiation source 12 generating radiation that is coupled via an optical fiber 14 to a handheld device 16 that can, in turn, apply the radiation to a subject's skin 18 in a manner discussed below. Radiation source 12 can be any suitable source providing radiation in a desired wavelength range, and, in the exemplary embodiment shown in FIG. 1, the radiation source 12 is an Er:glass laser.

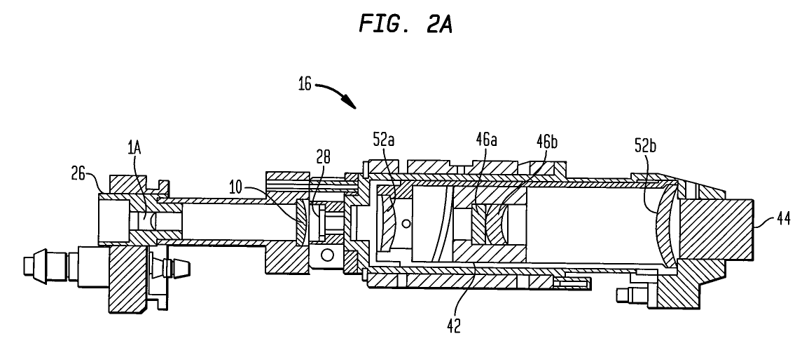

With continued reference to FIG. 1 as well as FIGS. 2A and 2B, in this exemplary embodiment, the device 16 includes a handheld housing 20 that can be coupled via the optical fiber 14 to the radiation source. The optical fiber 14 is disposed within an umbilical cord 22 that contains various optical, thermal and electrical communication paths between the handheld device 16 and the radiation source 12. Many other embodiments are possible, however. In some embodiments, the umbilical cord can further include electrical wires 24 to provide feedback and other control mechanisms as well as electrical connections from a base unit or peripheral device. In some embodiments, such wires can be employed for transmitting diagnostic signals from sensors disposed in the handheld device to a control unit and for transmitting control signals from the control unit to the device, as discussed further below. Similarly, the umbilical chord can contain a thermal conduction path for cooling elements of the handheld device, other device and/or for cooling tissue. In other embodiments, the umbilical chord may not contain certain connections, such as an optical pathway in an embodiment in which the EMR source is contained in the handheld device.

In this exemplary embodiment, the radiation from the optical fiber 14 is optically coupled via an input port 26, which is an 800 μm fiber tip, into the handheld device 16. A plurality of lenses 1A, 1B, and 1C, herein collectively referred to as lenses 1, deliver the radiation from the fiber as a collimated beam to other optical components of the device, which, in turn, cooperatively apply the radiation to the skin during operation, as discussed in more detail below. The relative spacing of the lenses are shown on FIG. 2B in units of millimeters. However, the spacing of lenses 46a-46b and 52a-52b will change when the magnification of the system is adjusted as described below.

Lens 1a is an aspheric lens with a 7.2 mm outer diameter and a 5.0 mm clear aperture. Lens 1b is 4.5 mm in diameter and 3.76 mm thick from apex to apex of the curved surfaces. Lens 1b has a concave surface (facing to the left in FIG. 2B) having a radius of curvature of 2.91 mm and a convex surface (facing to the right in FIG. 2B) having a radius of curvature of 4.41 mm. Lens 1c is a plano-convex field lens that has a diameter of 12.7 mm, a maximum thickness of 2.6 mm, and a convex radius of curvature of 20.6 mm. Lens 52a is 16.0 mm in diameter and 4.0 mm thick from apex to apex of the curved surfaces. Lens 52a has a concave surface (facing to the left in FIG. 2B) having a radius of curvature of 63.68 mm and a convex surface (facing to the right in FIG. 2B) having a radius of curvature of 17.53 mm. Lens 46a is 12.0 mm in diameter and 4.0 mm thick from apex to apex of the curved surfaces. Lens 46a has a convex surface (facing to the left in FIG. 2B) having a radius of curvature of 28.84 mm and a concave surface (facing to the right in FIG. 2B) having a radius of curvature of 312.5 mm. Lens 46b is 12.0 mm in diameter and 5.0 mm thick from apex to apex of the curved surfaces. Lens 46b has a concave surface (facing to the left in FIG. 2B) having a radius of curvature of 8.71 mm and a convex surface (facing to the right in FIG. 2B) having a radius of curvature of 11.83 mm. Lens 52b is 24.0 mm in diameter and 4.0 mm thick from apex to apex of the curved surfaces. Lens 46b has a concave surface (facing to the left in FIG. 2B) having a radius of curvature of 44.46 mm and a convex surface (facing to the right in FIG. 2B) having a radius of curvature of 20.74 mm.

Preferably, the surfaces of the lenses in device 10 are coated with appropriate anti-reflection coating so as to minimize, and preferably eliminate, reflection losses, thereby enhancing the efficiency of the device for applying radiation to the skin. One skilled in the art will appreciate that many other designs are possible to achieve the optical specifications of handheld device 16, and many other designs and specifications are possible beyond those described herein.

The use of the fiber 14 advantageously results in a radiation beam for coupling into the device 16 that exhibits a substantially homogeneous cross-sectional intensity distribution. In particular, the radiation beam generated by the source 12 undergoes multiple internal reflections as it traverses through the fiber. These reflections substantially homogenize the cross-sectional intensity of the output beam. In this exemplary embodiment, the optical fiber has an output tip with a diameter of about 800 microns and a numerical aperture of about 0.15, though other tip sizes and/or numerical apertures can also be utilized.

In some embodiments, the optical fiber 14 can be selected such that the output beam would have a desired cross-sectional shape. By way of example, as shown schematically in FIG. 2C, in some embodiments, the fiber 14 can have a tapered end 14a having a square cross-section so as to impart a similar cross-sectional shape to the output beam. The use of such a beam in some embodiments can be advantageous as it can lead to a more efficient utilization of the beam's power for treating the skin. In other embodiments, rather than employing a tapered fiber, an output beam of the fiber having a circular cross-section can be shaped by one ore more elements (it can be “clipped” by an iris) to generate a square cross-sectional shape. In other embodiments, an output beam having a circular cross-sectional shape can be employed. In general, the output beam's shape can be selected so as to maximize the efficiency of the application of the radiation to the skin.

Referring again to FIGS. 2A and 2B, the lenses 1A, 1B, and 1C collimate the fiber's output radiation and direct the collimated beam to an optical mask 28. The optical mask 28 transforms the radiation beam into a plurality of separate beams having smaller cross-sectional areas, which are herein referred to as beamlets, sub-beams or microbeams. The optical mask 28 can be composed of one ore more refractive and/or reflective optical elements. By way of example, the optical mask 28 can include one or more optical components that can cause a change in the phase of some portions of a beam relative to other portions thereof as the beam traverses through those components such that the beam is transformed into a plurality of beamlets.

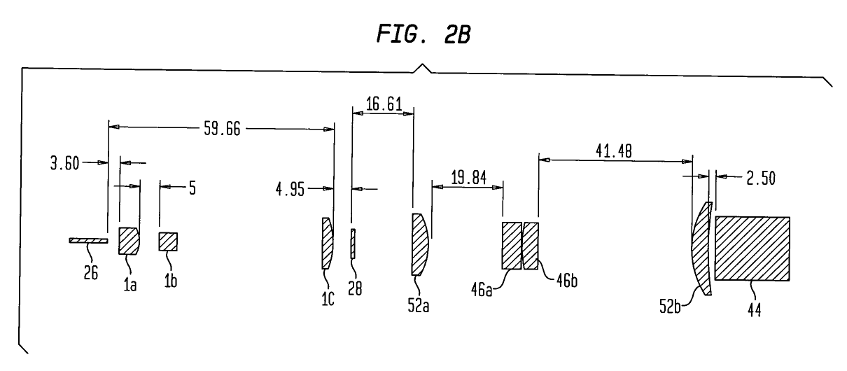

As shown schematically in FIGS. 3A and 3B, in this exemplary embodiment, the optical mask 28 is formed of a plurality of microlenses 30. As a radiation beam 32 passes through the microlenses, each microlens causes convergence of a portion of the beam incident thereon into a separate beamlet. In this manner, the beam 32 is transformed into a plurality of beamlets 34.

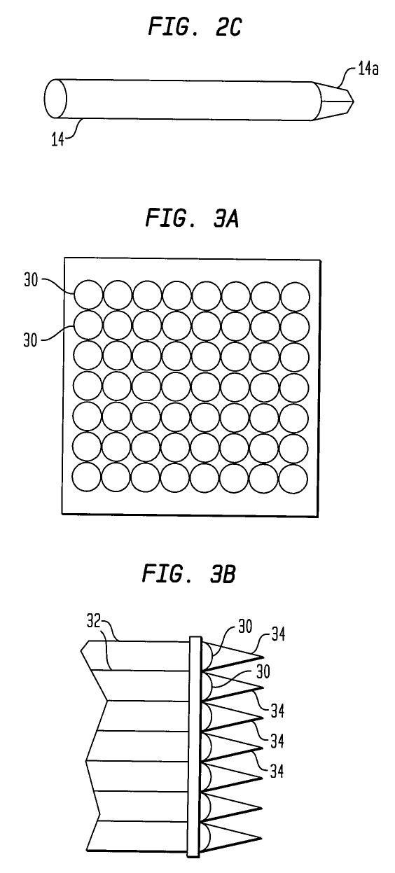

With reference to FIGS. 4A, 4B and 4C, the device 16 includes an optical mask assembly 36 that serves as a support or holder to position the optical mask 28. The optical mask 28 is removably and replaceably positioned in the optical path of device 10 by mounting the optical mask assembly 36 into a mechanical mount 38. The optical mask assembly 36 is secured to the mount by a set of magnetic detents 36a, which magnetically couple the optical mask assembly 36 to mechanical mount 38. The plurality of magnetic detents 36a align the optical mask support such that the optical mask 28 is positioned in the optical path of the EMR. This allows the user to readily remove and replace the optical mask 28 with another mask having different pitch, focus, or other parameters, as discussed further below. The optical mask support 36 can be decoupled from the mount 38, and the optical mask 28 thereby removed to allow another optical mask to be used. Although, many embodiments are possible, device 10 includes several different mask assemblies, each containing an optical mask having different parameters. The various optical mask assemblies are inserted into mount 38 depending on the application.

Referring to FIG. 3A, the individual lenses of microlens array 30 are spherical lenses, which impart a substantially circular cross-sectional shape to the beamlets. Device 16 includes three different interchangeable microlens arrays, but could include additional or fewer arrays. The lenses of each microlens array are oriented in regularly spaced patterns, either orthogonal or hexagonal patterns. The first microlens array comprises a regularly spaced orthogonal pattern of microlenses. The dimensions of the first microlens array are 7 mm×7 mm, with a pitch of 500 μm per microbeam. The second microlens array comprises a regularly spaced orthogonal pattern. The dimensions of the second microlens array are 10 mm×10 mm, with a pitch of 300 μm per microbeam. The third microlens array comprises a regularly spaced hexagonal pattern. The dimensions of the third microlens array are 15 mm×15 mm, with a pitch of 600 μm per microbeam. In other embodiments, other suitable microlens arrays, or other types of optical masks such as those described further below, can also be employed.

Referring to FIGS. 3A and 3B, When EMR is passed through the microlens array 30, each lens of the array creates a microbeam. Each microbeam has a spot size in a range of about 50 microns to about 300 microns, depending on the setting of the zoom lens system 42. The pitch of the resulting microbeams (i.e., the distance between the center points of any two adjacent and tangential microbeams) is adjustable within a range of about 300 microns to about 1000 microns.

The microlenses 30 can be formed by employing a variety of techniques known in the art, including lithographic techniques. Microlens arrays suitable for use in various embodiments are commercially available from, for example, Advanced Micro Optics Systems, GMBH of Staarbruecken, Germany.

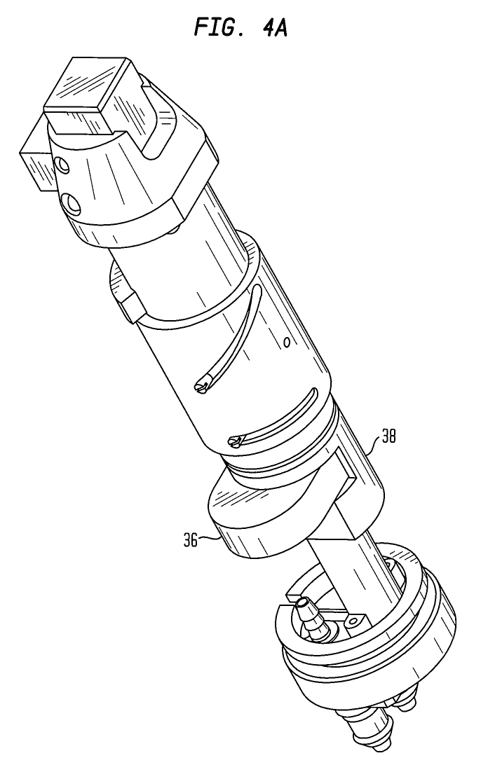

In this exemplary embodiment, the profiles of the microlenses 30 exhibit a selected degree of asphericity (that is, deviation from a spherical profile) so as to minimize, and preferably eliminate, spherical aberrations. By way of example, FIG. 5 schematically shows a surface profile 40a (shown as a sag of the surface as a function of radial distance from an optical axis “OA” of the lens) of such a microlens that substantially coincides with a putative spherical profile 40b (shown by dashed lines) at the intersection of the lens surface with the optical axis. FIG. 5 shows an increasing deviation from that spherical profile as a function of increasing distance from the optical axis.

Referring again to FIGS. 1 and 2A, the optical mask 28 (in this case a plurality of microlenses) directs the beamlets towards a zoom lens system 42, which images the optical mask 28 onto the skin, as discussed below. The zoom lens system 42 cooperatively provides an image of an object with adjustable magnification. As discussed in more detail below, in many embodiments, the zoom lens provides adjustable magnification while preserving the location of an image plane. In other words, the zoom lens system 42 provides adjustable magnification with parfocality (e.g., it is a parfocal inverting optical zoom system, although other configurations are possible). The zoom lens system 42 is designed to provide magnification in a range of about 1.43× to 2.14× while confining the movement of the image plane to a distance less than about 0.2 mm, and more preferably maintaining the image plane at a fixed location.

In this embodiment, the zoom lens 42 focuses the beamlets generated by the optical mask 28 through a radiation transmissive window 44, e.g., in the form of a sapphire block, into a plurality of skin portions (herein also referred to as islets or EMR-treated islets) separated from one another by untreated (or less treated, or differently treated) skin, as skin portions 18a shown schematically in FIG. 1. As discussed below, the zoom lens allows adjustment of the pitch of the islets (distance between the islets) by changing the magnification of the image of the optical mask that it forms, and hence adjusting the density of the islets formed within the skin.

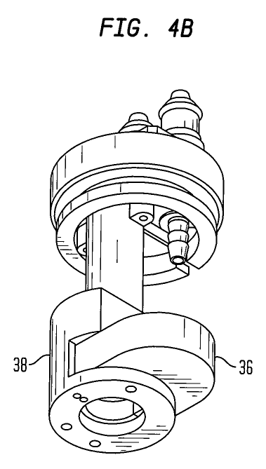

With reference to FIGS. 6A and 6B as well as FIG. 2B, in this exemplary embodiment, the zoom lens system 42 includes two pairs of lenses that are movable relative to one another. The lenses within each pair, however, are axially fixedly positioned relative to one another. More specifically, two lenses 46a and 46b (herein also referred to as lens pair 46) that form one of the pairs are mounted in a cylindrical enclosure 48 at a fixed axial distance relative to one another. The cylindrical enclosure 48 is adapted for positioning within another cylindrical enclosure 50. Lenses 52a and 52b (herein also referred to as lens pair 52) are attached to the ends of enclosure 50 to form the other lens pair. The cylindrical enclosure 50 is, in turn, disposed within another cylindrical enclosure 54, in a manner discussed below, that is connected via a flange 54a to an end block 56 of the device. In this manner, the lens 52a of the zoom system receives the beamlets generated by the optical mask and delivers a converging set of beamlets via the lens 46b to the contact window 44 to be transmitted to the tissue.

With continued reference to FIGS. 6A and 6B, when fully assembled, a rotational guide 58, e.g., a cam, is coupled to both of the cylindrical enclosures 48 and 50, which support the lens pair 46a-46b (attached to enclosure 48) and the lens pair 52a-52b (attached to enclosure 50). Cylindrical enclosure 48 fits within cylindrical enclosure 50, which, in turn fits within an outer cylindrical enclosure 54. Thus, when assembled, cylindrical enclosure 48 slides within cylindrical enclosure 50, which, in turn, slides within cylindrical enclosure 54.

A set of pins and slots control the relative motion of cylindrical enclosures 48 and 50. When assembled, pins 60a and 60b are attached to cylindrical enclosure 50. Pins 60a and 60b extend through two slots 72 (one of which is shown) located on opposite sides of the outer enclosure 54. Each pin 60a and 60b extends through one corresponding slot 72. The slots 72 extend in an axial direction and allow the pins 60a and 60b to slide along the axial direction. Pins 60a and 60b also extend through two corresponding slots 70a located on opposite sides of rotational guide 58. The slots 70a extend in a roughly spiral direction about rotational guide 58.

Similarly, when assembled, pins 74a and 74b are attached to cylindrical enclosure 48. Pins 74a and 74b extend through two slots 76a and 76b of rotational guide 58. Pin 74a extends through slot 76a, and pin 74b extends through corresponding slot 76b. Pins 74a and 74b also extend through two corresponding axial slots 78 formed in the outer enclosure 54 (one of which is shown), the pins 74a and 74b further extend through two corresponding slots 50a of cylindrical enclosure 50a. Like slots 72, the slots 78 and 50a extend in an axial direction and allow the pins to slide along the axial direction. Like slots 70a, slots 76 extend in a roughly spiral direction about rotational guide 58.

When fully assembled, the rotational guide 58 is placed around the outer enclosure 54 with the pins extending through the corresponding slots. In operation, the pins 60a-60b and 74a-74b and slots 70a, 76a-76b, 72, 78 and 50a control the relative motion of the lens pairs 46a-46b and 52a-52b. The pins reside within the intersections of the slots. Slots 76a and 76b intersect with corresponding slots 78 and 50a, which overlap each other. Similarly, slots 70a intersect with corresponding slots 72. As the rotational guide 58 is rotated about the outer enclosure 54, the point of intersection of the various corresponding slots changes, which forces the pins 60a-60b and 74a-74b to slide along the corresponding slots 72, 78 and 50a in the axial direction.

Further, the slope of spiral slots 70a has a steeper magnitude in the axial direction than the slopes of spiral slots 76a-76b. Thus, for a given amount of rotation of rotational guide 58 about outer enclosure 54, pins 74a-74b will move a greater distance than pins 60a-60b. Thus, lens pair 46a and 46b attached to enclosure 48 will move a greater distance than lens pair 52a and 52b attached to enclosure 50. The ratio of the slopes of the slots 70a to slots 76a-76b is 9:1. Thus, for a given amount of rotation of guide 58, lens pair 46a-46b will move nine times as far as lens pair 52a-52b. In this particular embodiment, lens pair 52a-52b exhibits a maximum axial excursion of about 1.54 mm while the lens pair 46a-46b has a maximum axial excursion of about 13.84 mm. Furthermore, the slopes of slots 76a-76b are opposite in direction to those of slots 70a. Thus, in operation, lens pair 46a-46b move in a direction opposite to lens pair 52a-52b.

The zoom lens system of FIG. 1 is designed such that the motion of the lens pairs changes a magnification of the image of the optical mask formed in the skin while ensuring that image plane remains substantially at a given skin depth. In this embodiment, the relative motion of the lens pairs relative to one another results in a magnification of the image in a range of about −1.43× to −2.14×. However, many other embodiments having different magnifications and ranges of magnifications are possible.

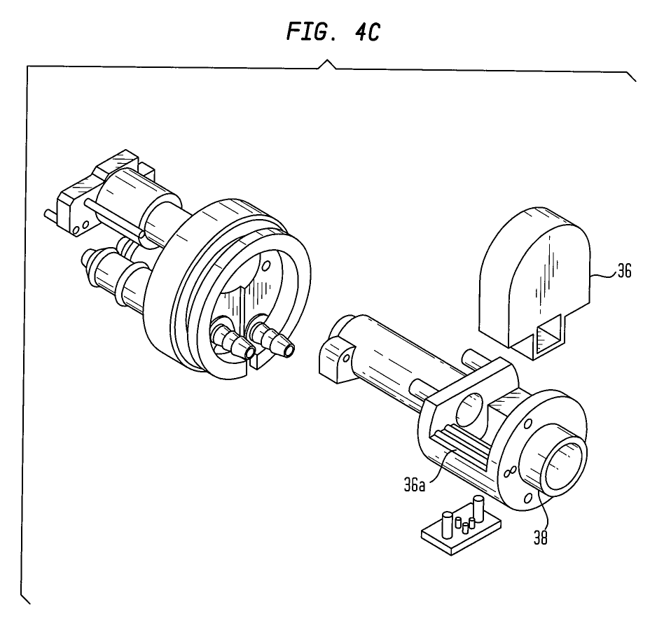

By way of further illustration, FIGS. 7A and 7B schematically show the passage of a plurality of radiation rays through the optical device 16 for two magnification settings of the zoom lens: −2.14× (FIG. 7A) and −1.4× (FIG. 7B). More specifically, these figures show the radiation received from the optical fiber 14 is collimated by the lens assembly 1 and is transmitted to the optical mask 28, which, in turn, delivers a plurality of beamlets 34 to the zoom lens system 42. The zoom lens system 42 focuses the beamlets to form an image (e.g., image A in FIG. 7A and image B in FIG. 7B) that comprises a plurality of focused spots (e.g., spots 80a in FIG. 7A and spots 80b in FIG. 7B), each of which corresponds to one of the beamlets. The focused spots in the image A formed by the zoom lens system at the higher magnification setting (FIG. 7A) are farther apart from one another than those in the image B formed by the zoom lens system at a lower magnification setting (FIG. 7B). In other words, the zoom lens system 42 allows adjusting the density of focused spots within the skin, as discussed further below.

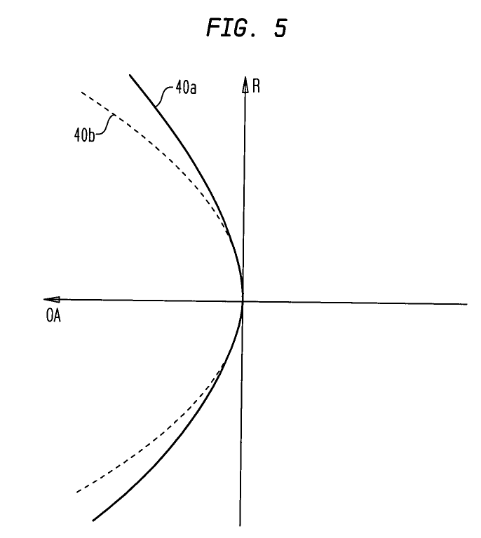

As noted above, in some embodiments, such as the exemplary device 16, the radiation from the zoom lens is applied to the skin via a radiation transmissive window, such as the sapphire block 44 (see, e.g., FIG. 1). In many such embodiments, the window 44 is cooled, via the flow of cooling fluid such as water, so as to remove heat from the epidermis during treatment. For example, as shown in FIGS. 8A and 8B, the window 44, which is mounted to the end block 56 at the distal portion of the device, can be in thermal contact with a cooling plate 82, which in turn is cooled via the flow of a fluid, e.g., water, over a back surface thereof. More specifically, a cooling fluid can be introduced via an input port 84a into one or more passages provided in the end block to remove heat from the plate 82. The fluid can then exit the block via an output port 84b.

One advantage to using a zoom lens system is that a thicker window 44 may be used to improve the cooling effect on tissue. Because the optical window can affect the optics of a system, a thin window (e.g., sapphire) is generally used to avoid degrading the optical properties of the EMR microbeams. However, by using a zoom lens system to control the pitch of the EMR microbeams, the optical window has a greatly reduced impact on the optical parameters of the system. Thus, a thicker window 44 may be used without materially degrading the optical properties of the system.

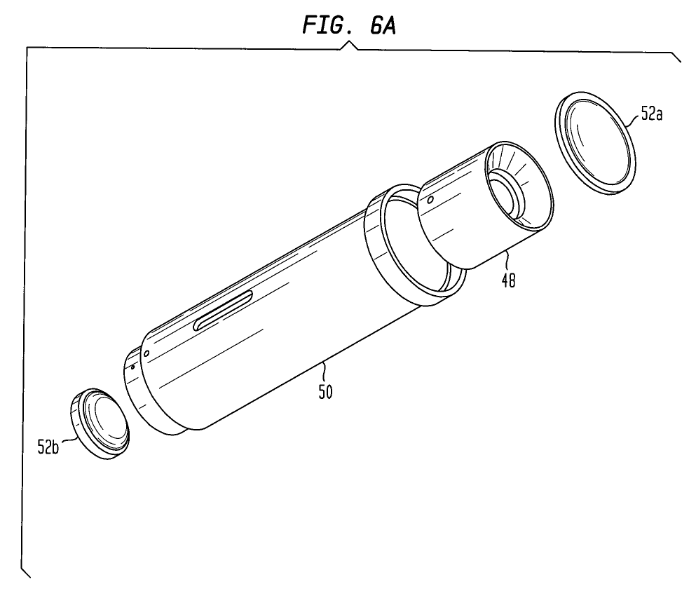

In operation, the transmissive window 44 can be placed in contact with a portion of the skin, as shown in FIG. 1, and the radiation source can be activated so as to apply radiation, e.g., treatment radiation, into a plurality of skin portions separated from one another by other portions (untreated or differently treated portions) of the skin. In other words, each beamlet is focused onto a skin portion that is separated from the skin portions in which other beamlets are focused. In this embodiment, the beamlets provide a lattice of EMR-treated islets in the tissue. As discussed above, the zoom lens system 42 allows adjusting the pitch of the EMR spots focused in the tissue (the distance between the spots), which corresponds to adjusting the density of the treated skin portions. By way of illustration, FIG. 9A shows a calculated lattice of EMR spots, which can be generated by employing an embodiment of the above device 16, with a pitch of about 175 microns for the focused spots, and FIG. 9B shows a calculated lattice of EMR spots, which can be generated by the device at a different (lower) magnification setting of the zoom lens, with a pitch of about 115 microns for the focused spots. The adjustment of the pitch of the focused spots can be advantageously utilized to optimize treatment of the skin for a variety of skin types and conditions, as discussed further below.

The operational specifications of device 10 are shown in the following table.

TABLE 1
Operational Specifications of Device 10

| | | 10 mm | |
|---|---|---|---|
| Handheld Device | 7 mm Orthogonal | Orthogonal | 15 mm Hexagonal |
| Treatment area, | 0.39 | 0.71 | 1.96 |
| cm² | | | |
| Pitch. mm | 500 | 300 | 600 |
| Focal distance | 0.4 | 0.2 | 0.2 |
| inside skin, mm | | | |
| Microbeam | 400 | 999 | 320 |
| (“MB”) density, | | | |
| 1/cm² | | | |
| Number of MB | 159 | 627 | 627 |
| per pulse | | | |
| Min energy of | 5 | 3 | 5 |
| MB (5 ms), mJ | | | |
| Max energy of | 33 | 5 | 8 |
| MB (5 ms), mJ | | | |
| Max energy of | 50 | 10 | 13 |
| MB (10 ms), mJ | | | |
| Speed of | 0.2 | 0.4 | 0.98 |
| treatment at | | | |
| 0.5 Hz, cm²/s | | | |
| Estimated time to | 25 | 12.5 | 5 |
| treat 300 cm² | | | |
| face, min | | | |

As noted above, a device according to the teachings of the invention, such as the above device 16, can be utilized to generate a pattern of treated portions of tissue that are separated from one another by non-treated (or differently treated, or less treated) tissue. As noted above, such treated portions are herein referred to as EMR-treated islets. By producing such islets, rather than continuous regions of EMR treatment, untreated regions (or differently- or less treated regions) surrounding the islets can act as thermal energy sinks, thus lowering the risk of bulk thermal damage. Further, when the EMR energy applied to the islets results in generating damage islets, the untreated regions (or differently, or less treated regions) can accelerate the healing process, as the regenerative and repair responses of the body occur at wound margins (i.e., the boundary surfaces between damaged and intact areas).

Hence, in many cases, it is desirable to increase the density of the treatment spots without the loss of the ability of the untreated portions to act as effective heat sinks. To this end, a device of the invention, such as the above device 16, allows the user to adjust the density of the treatment spots via the zoom lens system (in some embodiments, in combination with replacing the optical mask) so as to obtain an optimal density of the treatment spots within the skin. For example, a medical professional can utilize the zoom lens to start a treatment regimen with a relative low density of treatment spots. Based on the response of the skin (e.g., the temperature of the epidermis) and/or the treatment results, the density of the spots can be gradually increased by utilizing the zoom lens to obtain an optimal density of the EMR-treated islets. By way of example, the treatment flexibility provided by a dermatological device of the invention can advantageously be utilized to safely treat different types of skin, which can exhibit different chromophore concentrations (e.g., melanin in hair follicles). High absorption by certain types of skin, for example dark skinned individuals or people with very tanned skin, often makes certain treatments difficult. A device of the invention, however, allows adjusting the pitch of the treatment spots to deliver a safe amount of radiation to skin.

Many other embodiments other than device 10 are possible.

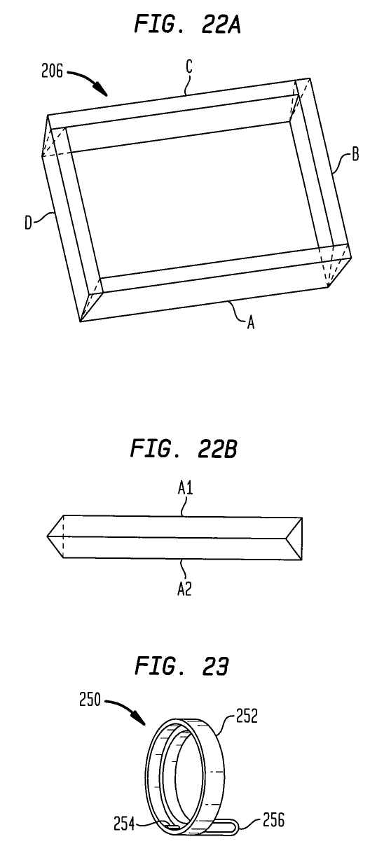

For example, while device 10 has been described as having a zoom lens system 42 that can be adjusted to any magnification within the range of possible magnifications, it may be preferable to include an additional detent mechanism that limits the potential settings of the zoom lens system to one of a set of predetermined settings. For example, referring to FIG. 23, the zoom lens system could include a detent mechanism 250 having four predetermined settings within the range of possible magnifications. Detent mechanism 250 includes a ring 252, a detent marker 254 (a sphere in this embodiment), and a spring 256. The detent mechanism 250 can be coupled to an end of rotational guide 58 shown in FIG. 6B. Corresponding recesses located on a corresponding portion of the handheld device accommodate marker 254 when the ring is rotated and the lenses are placed in the proper position. Spring 256 forces marker 254 into the recess to hold guide 58 in place. Such a mechanism may reduce the chance for error, by standardizing the settings of the system and further allowing a user to select the magnification based on predetermined parameters. Many other embodiments of a detent or other similar mechanism are possible.

In other embodiments, the settings may be selected to ensure that even at the lowest magnification (i.e., the highest density of spots) the treatment radiation can be safely applied to the skin. While in some embodiments, such discrete settings of the zoom lens can be implemented mechanically, in other embodiments, the lenses of the zoom lens system can be moved under the control of an electronic control circuitry to achieve a set of discrete magnifications. Alternatively, the electronic circuitry can be employed to continuously adjust the magnification provided by the zoom lens over a selected range.

Additionally, a variety of wavelengths of EMR can be utilized, including wavelengths ranging from 0.29 μm to approximately 12 μm. Although smaller wavelengths are possible, wavelengths greater than 0.29 μm are preferably used due to the potentially carcinogenic nature of smaller wavelengths. A preferred range for the embodiments described herein is 1.1 μm to 1.85 μm, with wavelengths of 1.54 μm and 1.06 μm being preferred.

In still other embodiments, the source of EMR may be a variety of coherent and non-coherent radiation sources, which can be employed alone or in combination with other sources. In some embodiments, the radiation source is a laser, such as a solid-state laser, dye laser, diode laser, or other coherent light sources. For example, the radiation source 12 can be a neodymium (Nd) laser, such as a Nd:YAG laser, a chromium (Cr), Ytterbium (Yt) or diode laser.

Another example of a coherent radiation source is a tunable laser. For example, a dye laser with non-coherent or coherent pumping that provides wavelength-tunable light emission can be employed. Typical tunable wavelength bands cover a wavelength range of about 400 to about 1200 nm with a bandwidth in a range of about 0.1 to about 10 nm. Further, mixtures of different dyes can provide multi wavelength emission. In some embodiments, the radiation source is a fiber laser. The wavelength range of such a laser is typically in a range of about 1100 nm to about 3000 nm. This range can be extended with help of second harmonic generation (SHG) or an optical parametric oscillator (OPO) optically connected to the fiber laser output. In other embodiments, diode laser can be used to generate radiation with wavelengths, e.g., in a range of about 400-100,000 nm. In some embodiments in which a system of the invention is employed for non-ablative skin remodeling, the radiation from the source 12 (e.g., Nd:YAG laser (1.34 microns), an Er:YAG laser (1.56 microns), or a diode laser (1.44 microns)) can be applied to the skin while cooling the surface to prevent damage to the epidermis.

Alternatively, in some embodiments, non-coherent radiation sources, such as incandescent lamps, halogen lamps, light bulbs can be employed. By way of example, monochromatic lamps, such as hollow cathode lamps (HCL), electrodeless discharge lamps (EDL), which generate emission lines from chemical elements, can be utilized.

Further, although the EMR is typically applied in a pulsed manner, in other embodiments, the EMR can also be applied in other ways, including continuous wave (CW) and quasi-continuous wave (“QCW”) radiation.

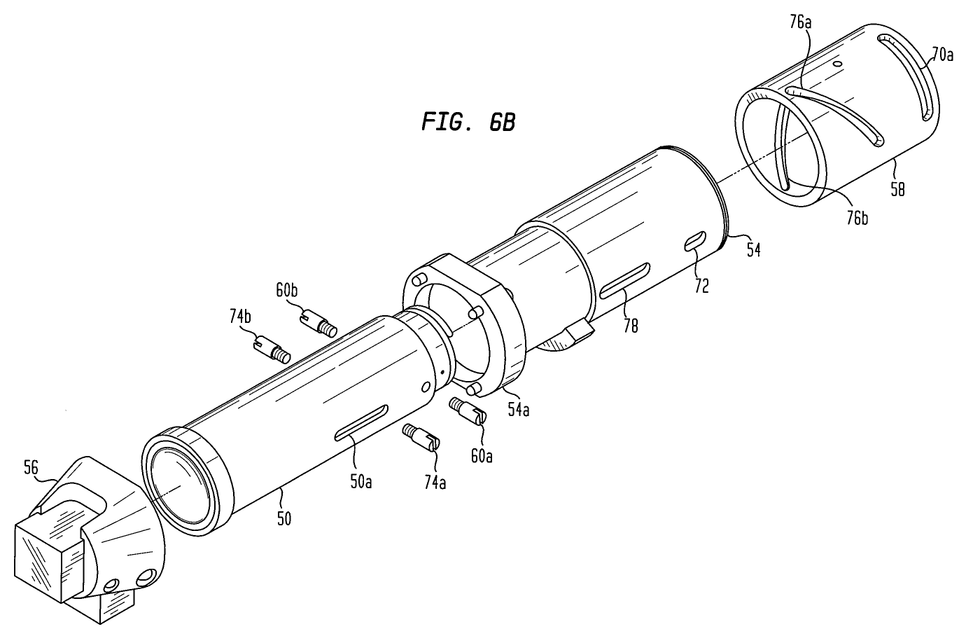

In another embodiment, FIG. 10 schematically shows a handheld dermatological device 86 according to an embodiment of the invention that receives radiation from a source 88, e.g., via an optical fiber 89, at a proximal end thereof, and applies that radiation to the skin at its distal end. Device 86 includes collimating optical assembly 88 for directing the received radiation to a phase mask 90, and a zoom lens system 92 that images the phase mask, e.g., through a radiation transmissive window 94, onto the skin. Similar to device 10, the zoom lens includes two pairs of lenses 96 and 98 that can be moved axially relative to one another. In this embodiment, piezoelectric elements 100 and 102 cause the movements of the lenses under instructions from a control unit 104. More specifically, sensors 106 and 108 coupled to the piezoelectric elements 100 and 102, respectively, send signals indicative of the locations of those lenses, e.g., relative to a fiducial reference location, to the control unit. The control unit, in turn, utilizes the information received from the sensors to apply appropriate voltages to the piezoelectric elements, e.g., via sensors 106 and 108, for moving the lens pairs relative to one another. In many embodiments, the relative movements of the lens pairs is configured, e.g., in a manner discussed above, so as to achieve parfocality.

With continued reference to FIG. 10, the device 86 can further include a user interface 110, in communication with the controller 104, that can allow a user to select, e.g., from a drop-down menu 110a, a desired magnification provided by the zoom lens. In response to such a selection, the control unit can cause the movements of the lens 96 and 98, e.g., by applying appropriate voltages to the piezoelectric elements 100 and 102, such that the zoom lens would provide the selected magnification.

In still other embodiments, many different patterns of microlenses in the array of microlenses are possible, such as hexagonal arrays and arrays of different types and shapes of lenses arranged in different patterns. Further, instead of using spherical lenses, the microlenses can be shaped such that the cross-sections of the beamlets exhibit other shapes, such as squares or lines, as discussed in more detail below. The definition of the term “pitch” may vary from that used above when applied to arrays of microlenses having different patterns (including both regularly and irregularly spaced patterns) and/or combinations of different lenses. However, the underlying concept of pitch, and adjusting the pitch of any resulting microbeams, is well understood in the art and is applicable to such alternate embodiments. Further, the theoretical range in which the pitch may be adjusted is any real value between zero and infinity. In practice, however, the pitch will be dictated by practical considerations, such as the size of the treatment area, the density of EMR-treated islets required for efficacious results, and the diameter of the microbeams that are produced.

One limitation on the pitch is the potential for skin tissue to blister at the dermal/epidermal junction. At high energy levels, individual EMR-treated islets may exhibit blistering at the dermal/epidermal junction, which is acceptable in most applications. However, as the density of the EMR-treated islets increases, bulk heating between the islets can occur, and blistering of the dermal/epidermal junction in tissue between the intended EMR-treated islets can occur, which is not generally acceptable or desired. Therefore, parameters (including power density, pitch, etc.) for various treatments of skin tissue will preferably be chosen to prevent blistering of the dermal/epidermal junction between the intended or actual EMR-treated islets.

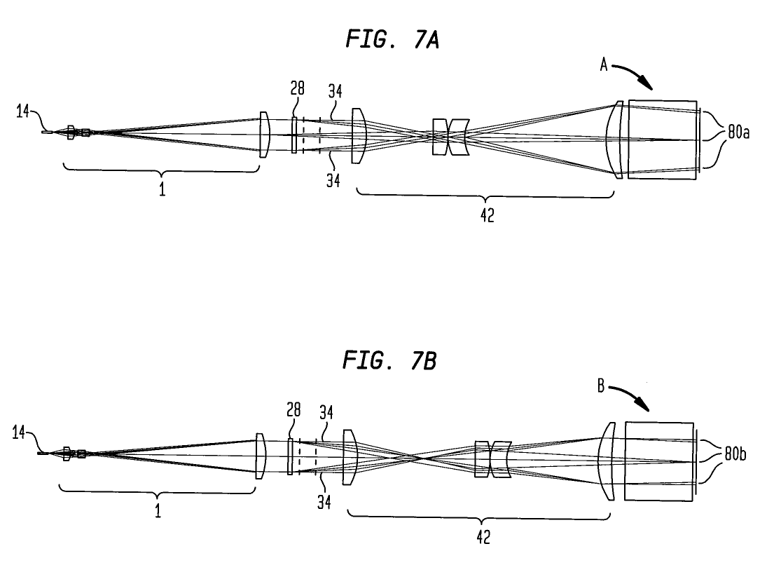

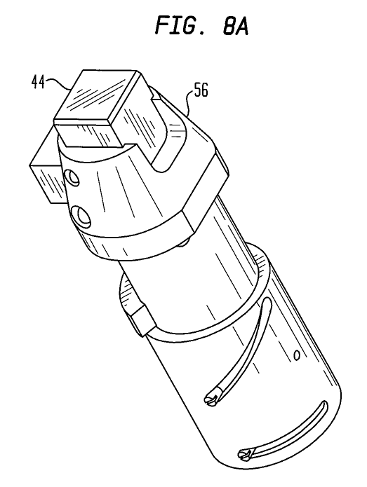

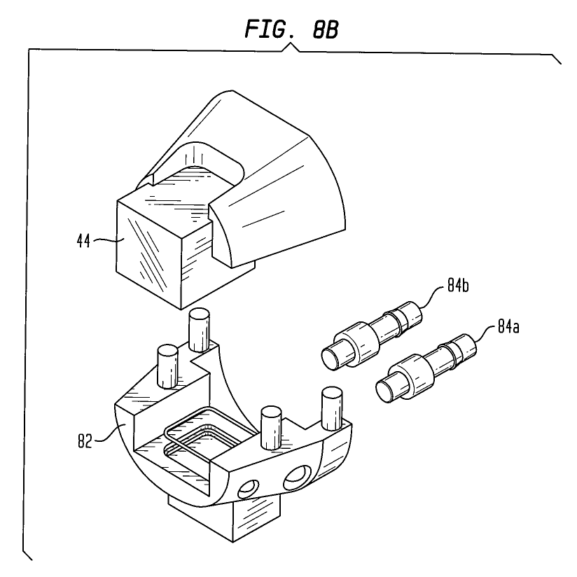

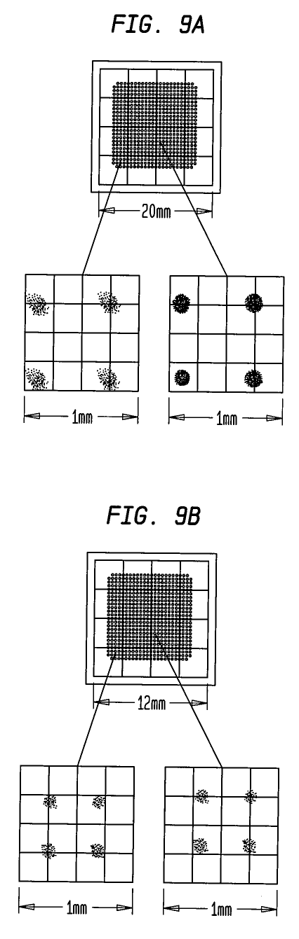

A variety of different types of optical elements can be employed in the practice of the invention, e.g., to obtain different shapes for the treatment regions. By way of example, FIG. 11 shows an optical mask 112 formed of a hexagonal pattern of focusing elements 114 while FIG. 12 shows another optical mask 116 formed of a square pattern of focusing elements 118. By way of other examples, FIGS. 13A and 13B show optical masks 120 and 122, respectively, formed of matrix arrays 124 and 126, respectively, of cylindrical lenses. By way of example, the cylindrical lenses can provide a line focus rather than a substantially circular focus. As another example, FIG. 14 shows another optical mask 128 that can generate a plurality of beamlets by passing the incident radiation through two layers of cylindrical lenses 130a and 130b.

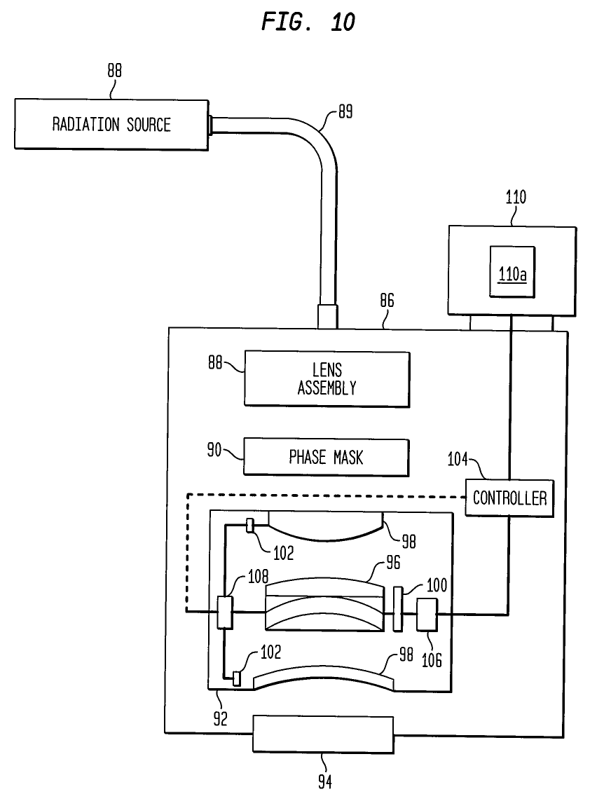

Other embodiments can create the array of beamlets using other mechanisms. For example, the beam may be scanned over a discrete number of orientations, e.g., in synchrony with activation of the source. In still other embodiments, the optical mask can rely on reflection to spatially displace a beam (or a plurality of beams) so as to cause irradiation of different portions of tissue. By way of example, FIG. 15 schematically depicts a optical mask 132 that employs a rotating mirror 134 that can be rotated about an axis A, in synchrony with activation of a radiation source, to direct a radiation beam, e.g., one delivered by an optical fiber 131 via lenses 133 and 135, into a zoom lens 136 at a plurality of discrete orientations, where each orientation would result in focusing the radiation to one of a matrix of EMR-treated islets in the skin. Further examples of optical masks suitable for use in the practice of the invention can be found in Published U.S. Patent Application No. 2006/0058712 and U.S. Pat. No. 6,997,923, both of which are herein incorporated by reference in their entirety.

In some embodiments, the handheld dermatological device not only allows changing the density of the treatment spots within the skin but it also allows adjusting the skin depth at which the radiation is focused. By way of example, referring again to FIG. 2A, the array of microlenses 30 in the above exemplary device 16 can be readily replaced with another having a different focusing property (e.g., one having lenses with different focal lengths) so as to focus the radiation at a different skin depth.

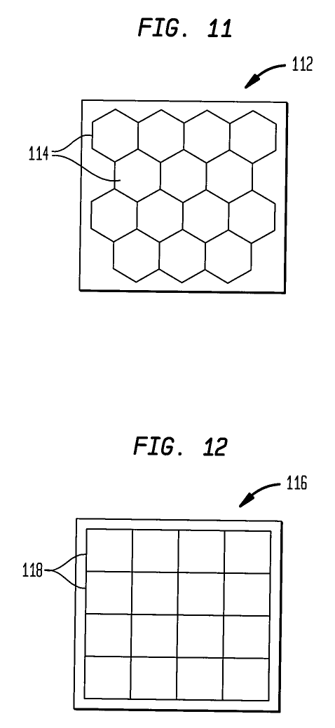

Alternatively, in some alternative embodiments, two or more optical masks, each having a different focusing property, are provided in the device such that each can be selected for particular applications. By way of example, as shown in FIG. 16, one such embodiment can include a holder 138 in which two or more optical masks, such as optical masks 140 and 142, with different focusing properties, e.g., different microlens arrays, can be disposed. The holder 138 can be rotated, e.g., mechanically or by application of electrical signals, to interchangeably place one of the two lens arrays in the path of the incident radiation. Alternatively, one removable assembly may contain some or all of the optical masks, which can be slid or rotated into position, depending on the application. In still other embodiments, all of the masks are contained in the handheld device, and the removable assembly is replaced with a non-removable mechanism.

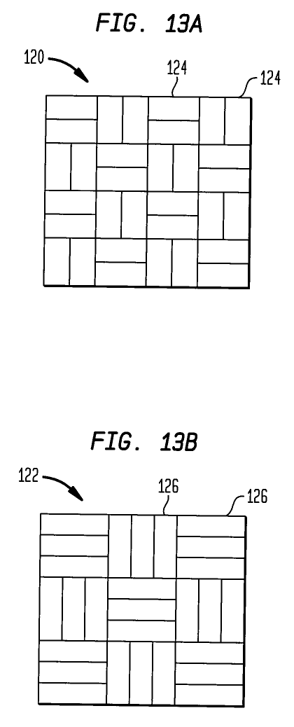

In other embodiments, the distance of the optical mask relative to the zoom lens can be adjusted so as to change the skin depth at which the radiation is focused. By way of example, FIG. 17 schematically depicts a dermatological device 144 that receives radiation from a source 146, e.g., via an optical fiber 145, and delivers that radiation to the skin via a window 151. The device 144 includes a mount 148 to which an optical mask 150 is mounted. The mount 148 is adjustable, allowing the optical mask to be positioned at one of two different distances from a zoom lens 152. The radiation delivered by the fiber 145 is directed via a lens assembly 153 to the optical mask 150, which, in turn, directs the radiation to the zoom lens 152.

Alternatively, the mount could be adjustable to additional discrete settings or is could be adjustable to any position within a range of positions. With reference to FIG. 17B, the mount 148 includes two recesses 148a and 148b, in each of which the optical mask 150 can be removably and replaceably positioned, via magnetic detents. By way of example, when a shallower depth of focus is desired, the optical mask can be inserted in the recess 148a and when a deeper depth of focus is needed, it can be inserted in the recess 148b.

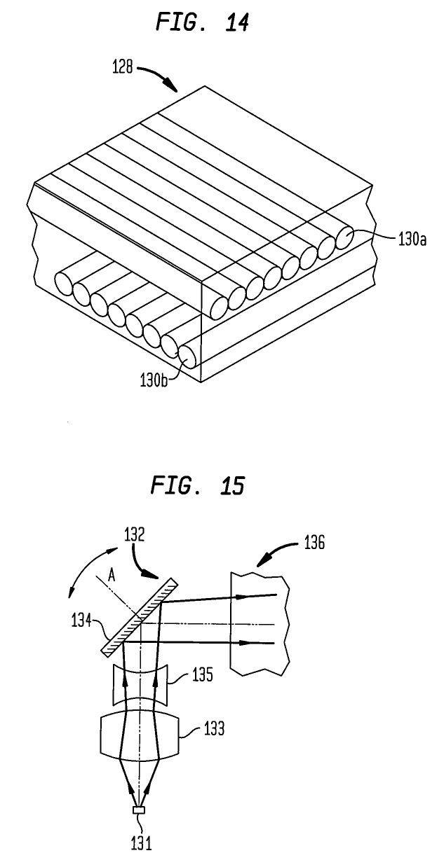

In other embodiments, an optical mask can be moved continuously, e.g., under control of a controller, over a selected range to allow a continuous adjustment of the depth of radiation focus over a selected portion of the skin. By way of example, FIG. 18 schematically depicts a handheld dermatological device 154 in accordance with such an embodiment that includes an optical mask 156 that receives a radiation beam from a source 158, e.g., via an optical fiber 160 and a lens assembly 162, and transforms the radiation beam into a plurality of beamlets to be delivered to a zoom lens system 164. The zoom lens, in turn, focuses the beamlets into a plurality of skin portions, e.g., via a window 163 in a manner discussed above in connection with the previous embodiments. The optical mask 156 can be moved via a plurality of piezoelectric elements 166 along a track 168 over a selected distance range. More specifically, in this embodiment, a position sensor 170, which is in communication with the piezoelectric elements, can determine the axial location of the optical mask relative to a fiducial reference, and provide this information to a controller 172. The controller can be disposed in the handheld device, or can be external to the device and in communication therewith, e.g., via one or more wires such that those shown in the umbilical cord of FIG. 1.

The controller 172 can, in turn, apply appropriate voltages to the pierzoelectric elements to move the optical mask so as to cause the focusing of the radiation at a given skin depth, as instructed by a user. For example, the device 154 can include a user interface 174, in communication with the controller 172, that can allow a user to select a depth of focus, e.g., from a list of choices presented in a drop down menu, or to input a desired depth of focus within a given range. Upon such a selection by the user, the controller applies appropriate voltages to the piezoelectric elements, based on the user's choice and the position of the optical mask reported by the sensor, to cause the radiation to be focused at the desired skin depth. In some cases, the controller can determine the appropriate position of the optical mask for a desired depth of radiation focus by consulting a pre-loaded calibration table indicating correlations between a plurality of positions of the optical mask and a plurality of respective depths of the skin at which the radiation is focused.

The dermatological devices according to various embodiments of the invention can be employed to apply radiation to the skin at a variety of skin depths, e.g., ranging from the skin surface to a depth of about 30 mm or more. By way of example, in some cases, a pattern of radiation can be applied to the stratum corneum to enhance its permeability (e.g., by generating micropores), e.g., to facilitate drug delivery to the skin. In other cases, a dermatological device of the invention can be utilized to generate a plurality of EMR-treated islets at a greater depth within the skin so as to treat the skin. By way of example, the radiation can be applied for hair removal, or to treat various pathological conditions of a tissue, such as vascular lesions, warts, and psoriasis plaque. Other applications of a device of the invention include skin rejuvenation, skin texturing, hypertrophic scar removal, skin lifting, stretch mark removal, and improved wound healing. These and other applications for which the dermatological devices of the invention are suitable can be found in the aforementioned U.S. patent and published U.S. patent application entitled, respectively, “Method and Apparatus for EMR Treatment” and “Methods and Products for Producing Lattices of EMR-Treated Islets in Tissues, and Uses Thereof,” which list a number of tissue treatments that can be achieved by generating a pattern of EMR-treated islets in the tissue.

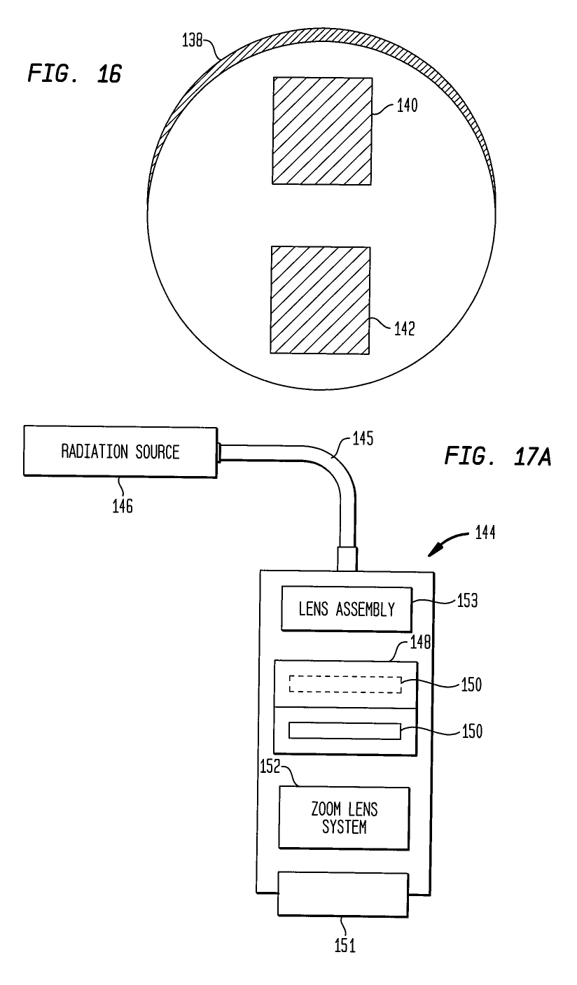

While in the above embodiments, a handheld dermatological device of the invention receives radiation from an external source, e.g., via an optical fiber, in other embodiments, a source of radiation can be incorporated into the handheld device itself. By way of example, FIG. 19 schematically depicts a dermatological device 176 according to one such embodiment that includes a handheld housing 178 in which various optical components of the device are disposed. In particular, a radiation source 180 is disposed in the housing 178 for generating radiation. The radiation source 180 can provide continuous or pulsed radiation. By way of example, in some embodiments, the radiation source 180 can be a laser, such as a Q-switched Nd:YAG laser. In this embodiment, the path of radiation emitted by the source 180 is folded back via two reflectors (e.g., mirrors) 182a and 182b to be directed to a collimator lens 184, which, in turn, delivers a collimated radiation beam to a optical mask 186. A variety of optical masks, such as those discussed above can employed. The optical mask delivers a plurality of beamlets (or scans a single beam into a plurality of discrete orientations) onto a zoom lens system 188. The zoom lens, in turn, focuses the radiation, e.g., through a radiation transmissive window 190, into the skin. By way of example, the zoom lens system can be constructed and operated in a manner discussed above. In some embodiments, cooling mechanisms, such as those discussed in connection with the above embodiments, can be employed to cool a surface of the transmissive window that is adapted for contact with the skin.

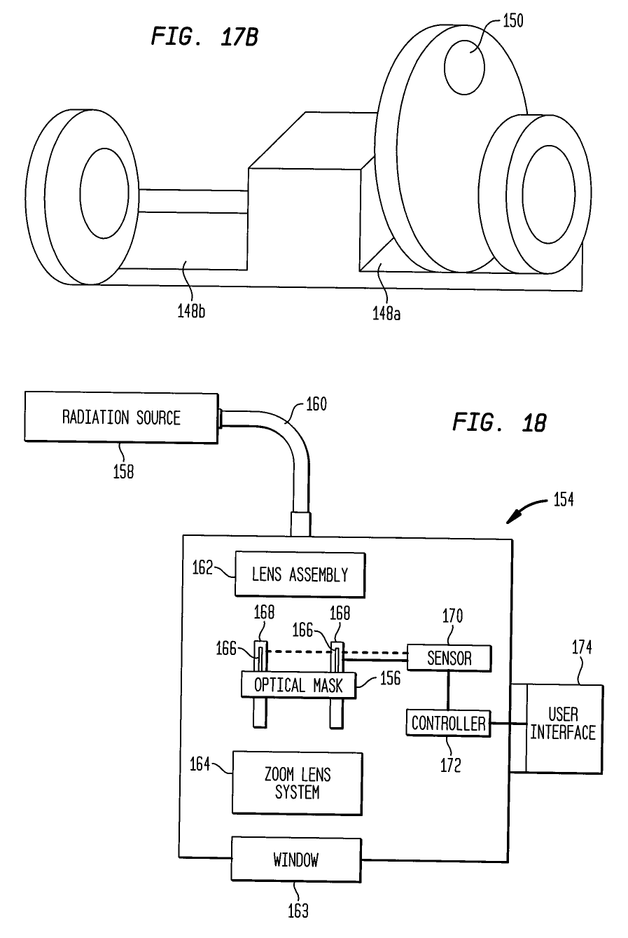

In some cases, it is desirable to be able to view the surface of a skin portion while the treatment radiation is applied through that surface to the skin. By way of example, FIG. 20 schematically depicts a handheld device 192 according to one such embodiment that includes a radiation transmissive window 194 through which radiation is applied to the skin. By way of example, the device can include a plurality of optical components, such as those discussed above, for receiving radiation from a source (or a source can be incorporated in the device itself) and delivering radiation to the skin. In particular, the radiation enters the window through a top surface 194a thereof and is delivered to the skin via a bottom surface 194b, which is adapted for contact with (or being in proximity of) a skin portion 196. A prism 198 coupled to the proximal portion of the device 192 is in contact with a side surface of the window 194c. At least a portion of ambient light illuminating the surface of the skin portion 196, which is reflected from the skin to enter the window 194, is coupled via the side surface 194c to the prism. A portion of this light leaves the prism via a surface 198a thereof, thus allowing an observer to have a side view of the skin portion 198. In the absence of the prism, in many cases, the light returning from the skin into the window 194 undergoes total internal reflections at the side surfaces of the window, thus inhibiting viewing of the skin surface. The prism, however, can have an index of refraction closer to that of the window than air, thus allowing the light to escape the window to be viewed by an observer. In some embodiments, a light source 200, e.g., a light emitting diode (LED), is coupled to the distal end of the device to illuminate the skin portion under observation so as to further facilitate its viewing by an observer.

A dermatological device of the invention can be utilized in a sliding or a stamping mode. In the sliding mode, the device can be moved over the skin while in contact with the skin. In the stamping mode, the device is placed over a portion of the skin and radiation is applied to the skin while the device remains stationary. Subsequently, the device is moved to another skin portion to apply radiation thereto. In other words, in the stamping mode, the radiation is applied to the skin via discrete movements from one portion of the skin to another.

As noted above, in general, the radiation is applied to the skin through a surface of a transmissive window of the device. In many cases, this surface is pressed against the skin to ensure a substantially uniform contact area between the device and the skin, thereby enhancing the treatment result. In the stamping mode, there is typically a need to identify the area of the skin to which the radiation is applied, e.g., to ensure a substantially uniform treatment of all segments of a target area requiring treatment (e.g., to avoid potentially over-treating one portion and missing others).

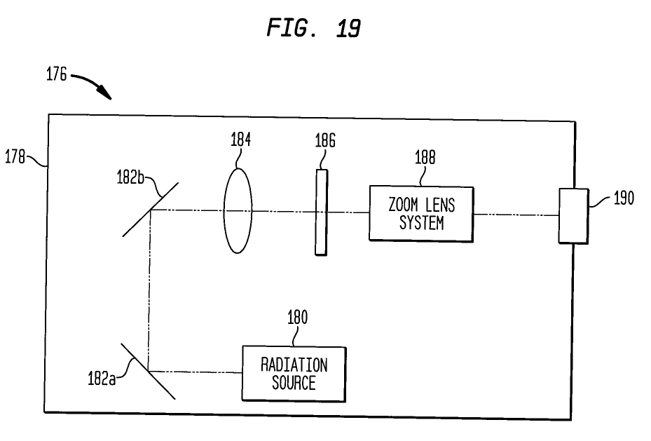

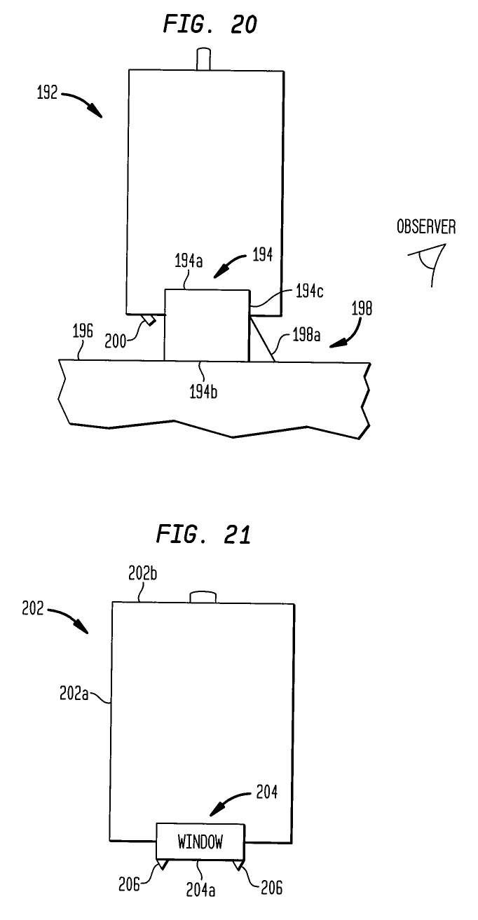

In some embodiments, a dermatological device of the invention includes an indicator that is coupled to the distal end (the end at which radiation is applied to the skin) of the device to show, at least temporarily, the surface borders of a skin portion to which radiation has been applied, e.g., by causing a transient impression in the skin. By way of example, FIG. 21 schematically depicts such a device 202 having a handheld housing 202a that receives radiation through a proximal portion 202b thereof and applies radiation to the skin through a surface 204a of a radiation transmissive window 204, e.g., sapphire block. The device can include a plurality of optical components, such as an optical mask and a zoom lens, for directing radiation to the skin. A flexible indicator 206 surrounds the boundary of the surface 204a of the window. With reference to FIGS. 22A and 22B, in this embodiment, the indicator 206 has four sides A, B, C and D, each of which extends from a substantially rectangular top surface to a tip or ridge that is adapted for contact with the skin (e.g., a top surface A1 and a tip A2 shown for the side A). The indicator 206 can be formed of a soft polymeric or other material, and the tip can be configured such that upon pressing the indicator against the skin with a moderate pressure it can form a transient impression in the skin without damaging the skin, or causing substantial discomfort to the patient. Thus, the indicator temporarily delineates the area of the skin surface through which radiation has been applied to the skin, by leaving a mark of the boundary on the surface of the skin.

By way of example, when utilizing the device in a stamping mode, the device's window can be pressed against the skin surface via the flexible indicator 204 to apply a dose of radiation to the skin. Subsequently, the device can be lifted and moved to another skin portion to apply radiation thereto. The transient impressions made by the indicator 204 show the user at least the surface of the latest skin portion that has been treated. This will allow the user to closely align the window of the device to the previously treated areas, which will avoid multiple treatments of the same skin segment, or excessively overlapping treatments. This may allow safer, more efficient, and/or more efficacious treatments.

### Equivalents

Those having ordinary skill in the art will appreciate that various changes can be made to the above embodiments without departing from the scope of the invention. While only certain embodiments have been described, it will be understood by those skilled in the art that various changes in form and details may be made therein without departing from the spirit and scope as defined by the appended claims. Those skilled in the art will recognize, or be able to ascertain using no more than routine experimentation, many equivalents to the specific embodiments described specifically herein. Such equivalents are intended to be encompassed in the scope of the appended claims.

### Numerical Ranges

As used herein, the recitation of a numerical range for a variable is intended to convey that the embodiments may be practiced using any of the values within that range, including the bounds of the range. Thus, unless otherwise noted, for a variable which is inherently discrete, the variable can be equal to any integer value within the numerical range, including the end-points of the range. Similarly, for a variable which is inherently continuous, the variable can be equal to any real value within the numerical range, including the end-points of the range, unless otherwise noted. Finally, the variable can take multiple values in the range, including any sub-range of values within the cited range.

Or. As used herein, unless specifically indicated otherwise, the word “or” is used in the inclusive sense of “and/or” and not the exclusive sense of “either/or.”

As used herein, EMR includes the range of wavelengths approximately between 200 nm and 10 mm. Optical radiation, i.e., EMR in the spectrum having wavelengths in the range between approximately 200 nm and 100 μm, may preferably be employed in some of the embodiments described above, but, also as discussed above, many other wavelengths of energy can be used alone or in combination. Also as discussed, wavelengths in the higher ranges of approximately 2500-3100 nm may be preferable for creating micro-holes using ablative techniques.

The term “optical” (when used in a term other than term “optical radiation”) applies to the entire EMR spectrum. For example, as used herein, the term “optical path” is a path suitable for EMR radiation other than “optical radiation.”

### ADDITIONAL DOCUMENTS INCORPORATED BY REFERENCE

Additional information related to this subject matter of this application can be found in the following documents, each of which is incorporated herein by reference: U.S. Pat. No. 6,997,923, United States Patent Application Publications US 2006/0058712 A1, US 2006/0020309 A1, US 2006/0004347 A1 and US 2006/0004306 A1, and U.S. Provisional Patent Application 60/620,734, 60/641,616, 60/614,382, 60/561,052 and 60/868,982.

What is claimed is:

1. A dermatological optical device, comprising
at least one optical mask adapted to receive a radiation beam and to transform said beam into a plurality of beamlets, and
a zoom lens system coupled to said mask so as to receive said beamlets, said zoom lens system being capable of focusing said beamlets into a plurality of separated skin portions.

2. The device of claim 1, wherein said zoom lens system provides an adjustable image magnification having an absolute value in the range of about 0.5 to about 5.

3. The device of claim 2, wherein said zoom lens system provides said adjustable magnification while substantially preserving locations of said focused beamlets within the skin at different magnifications.

4. The device of claim 1, wherein said optical mask comprises a plurality of microlenses.

5. The device of claim 4, wherein each of said microlenses generates one of said beamlets.

6. The device of claim 1, further comprising a holder in which said optical mask can be removably and replaceably placed so as to be in a path of the radiation beam.

7. The device of claim 6, wherein said holder can be removably and replaceably coupled to a body portion of said device.

8. The device of claim 7, further comprising one or more magnetic detents for coupling of the holder to the body portion.

9. The device of claim 1, wherein said zoom lens system comprises two pairs of lenses, wherein said lens pairs are movable relative to one another so as to provide said magnification range.

10. The device of claim 9, wherein said lens pairs are adapted to move relative to one another so as to substantially preserve locations of said focused beamlets in the skin while changing magnification provided by the zoom lens.

11. The device of claim 10, wherein the lenses of said lens pairs are coupled to two ends of a cylindrical enclosure and the lenses of the other lens pairs are coupled to two ends of another cylindrical enclosure, wherein one of said cylindrical enclosures can be axially disposed within the other cylindrical enclosure.

12. The device of claim 11, further comprising a rotational guide coupled to said cylindrical enclosures, said rotational guide being adapted to cause axial motions of said lens pairs in opposite directions at a relative rate adapted to change magnification of an image of said beamlets in the skin while substantially preserving location of said image.

13. The device of claim 12, further comprising a detent mechanism coupled to said rotational guide to allow a plurality of discrete magnification settings of said zoom lens system.

14. The device of claim 13, wherein said detent mechanism comprises a ring, a detent marker and a spring couple to said ring.

15. The device of claim 1, wherein said zoom lens comprises a parfocal inverting optical zoom system.

16. The device of claim 1, further comprising a radiation transmissive window adapted for contact with the skin through which the radiation is applied to the skin.

17. The device of claim 16, further comprising a handheld housing to which said optical mask, said zoom lens and said transmissive window are mounted.

18. The device of claim 16, wherein said handheld device comprises an end block to which said transmissive window is coupled, said end block comprising a plurality of passages for flow of a fluid thereof so as to extract heat from said window.

19. The device of claim 4, wherein at least one of said microlenses exhibits an aspherical profile characterized by a conic constant in a range of about 0 to about 10.

20. The device of claim 1, further comprising one or more electrically actuable elements coupled to said zoom lens system for adjusting magnification thereof.

21. The device of claim 20, wherein said electrically actuable elements comprises one or more piezoelectric elements coupled to a plurality of lenses of said zoom lens system for causing axial motions thereof.

22. The device of claim 20, further comprising a sensor coupled to said zoom lens for providing information regarding position of at least one of said lenses relative to the others.

23. The device of claim 22, further comprising a controller in communication with said sensor and with at least one of said actuable elements, said controller effecting application of one or more signals to said actuable element based on information provided by said sensor.

24. The device of claim 7, wherein said body portion is adapted for interchangeably positioning said optical mask holder at least two different distances from the zoom lens system.

25. The device of claim 5, further comprising one or more electrically actuable elements coupled to the holder for moving thereof relative to the zoom lens system.

26. A handheld dermatological device, comprising
a optical mask adapted to receive a radiation beam,
a zoom lens system coupled to said optical mask to generate an image of the optical mask in the skin.

27. The device of claim 26, wherein said zoom lens provides adjustable magnification of said image while substantially preserving location of said image within the skin.

28. The device of claim 26, wherein said optical mask comprises a plurality of microlenses.

29. A handheld dermatological device, comprising
a port for receiving radiation from a radiation source,
a holder in which at least two optical masks can be disposed, said holder being adapted for interchangeably positioning one of said phases mask in a path of the radiation, and
a zoom lens system optically coupled to said optical mask so as to generate an image thereof in the skin.

30. The handheld device of claim 29, wherein said zoom lens provides adjustable magnification in a range of about 0.5 to 5.0 or −0.5 to 5.0.

31. The handheld device of claim 29, wherein said zoom lens provides said adjustable magnification while substantially preserving a location of said optical mask image at different magnification values.

32. A handheld dermatological device, comprising
a handled housing, said housing including
a radiation source,
a optical mask for receiving radiation from said source, and
a zoom lens system in optical communication with said optical mask to generate an image of said optical mask in the skin.

33. The dermatological device of claim 32, wherein said zoom lens is adapted to provide adjustable magnification of said image while substantially preserving the image's location.

34. The dermatological device of claim 32, wherein said radiation source comprises a solid state laser.

35. A handheld dermatological device, comprising
a handheld housing,
a radiation transmissive window coupled to said housing, said window being adapted for receiving radiation through a surface thereof and applying the radiation to the skin via an opposed surface,
a prism optically coupled to said window to facilitate viewing of a skin portion to which radiation is applied.

36. The dermatological device of claim 35, further comprising a light source coupled to said housing for illuminating the skin so as to facilitate viewing of the skin portion.

37. A handheld dermatological device, comprising
a handheld housing,
a radiation transmissive window coupled to said housing, said window having a surface adapted for contact with the skin,
a flexible indicator coupled to said surface to cause a transient impression on the skin so as to delineate a surface boundary of a skin portion to which radiation is applied.

38. The dermatological device of claim 37, wherein said indicator is formed of a soft polymeric material.
